(19) United States
(12) Patent Application Publication
(10) Pub. No.: US 2005/0286510 A1
(43) Pub. Date: Dec. 29, 2005

(54) Packet transfer apparatus

(76) Inventors: Jun Nakajima, Yokohama (JP); Hiroaki Miyata, Yokohama (JP); Shinsuke Shimizu, Yokohama (JP); Migaku Ota, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/922,946

(22) Filed: Aug. 23, 2004

(30) Foreign Application Priority Data
Jun. 25, 2004 (JP) 2004-187224

(51) Int. Cl. H04L 12/50; H04Q 11/00

(52) U.S. Cl. 370/386

(57) ABSTRACT

A packet transfer apparatus for accommodating a plurality of hosts to transfer packets between the plurality of hosts and an ISP network. Upon receipt of a connection authentication request from a host, the packet transfer apparatus transmits ID and password information (information required for authentication) included in the request to an authentication server in the ISP network, acquires IP address information for the host from the authentication server, and notifies a DNS server in the ISP network of the IP address information, and previously registered domain name information of the host.

### INCORPORATION BY REFERENCE

The present application claims priority from Japanese application JP2004-187224 filed on Jun. 25, 2004, the content of which is hereby incorporated by reference into this application.

### BACKGROUND OF THE INVENTION

1. Field of the Invention

The present invention relates to a packet transfer apparatus which has functions of accommodating terminals, and associating Internet Protocol (herein-after called “IP”) addresses dynamically assigned to the terminals with user domain names for registration in a Domain Name System (hereinafter called “DNS”) server.

2. Description of the Related Art

When a subscriber connects a terminal to the Internet through an Internet service provider (hereinafter called “ISP”) for making communications, the ISP authenticates the subscriber using the Point-to-Point Protocol (hereinafter called “PPP”) in order to determine whether or not the subscriber should be allowed to connect to the Internet. The PPP is a protocol for connecting a terminal of a subscriber to an access point of ISP (for example, an authentication server) in a one-to-one relationship. In communication networks at the beginning of the introduction of the Internet, a terminal attempted a dial-up connection for establishing a connection to an access point of ISP through a telephone network, and was authenticated by PPP before the terminal was connected to the Internet for making communications.

However, with a transition to a full-time connection to the Internet, currently, a terminal is connected to an access point of ISP through an access carrier network (hereinafter called the “access network=38 ) which uses Internet Protocol (hereinafter called “IP”) different from a normal telephone network.

In this topology, since the authentication using the PPP, which is a second layer protocol of the OSI basic reference model, is performed through an access network which s a third layer network of the OSI basic reference model, a means is required for transferring PPP packets to a PPP network server on the ISP side. This means is implemented by Layer-2 Tunneling Protocol (hereinafter called “L2TP”) defined in RFC2661 (2.0 Topology, 3.0 Protocol Overview, 5.0 Protocol Operation, and 5.5 Keepalive) (Related Art 1) which is the standard of IETF (Internet Engineering Task Force).

L2TP is a protocol for encapsulating PPP packets with IP packets (hereinafter, this IP packet is called the “L2TP packet”) for transfer in order to pass the second layer PPP packets on a third layer network. L2TP generates a virtual communication path (tunnel) on a communication network, and builds a virtual communication path for transferring PPP packets using the tunnel for establishing a connection. This virtual communication path, which is called “L2TP connection (L2TP tunnel or L2TP session), is built on an access network by an L2TP access concentrator (hereinafter called “LAC”) installed in a terminal of a subscriber and an L2TP network server (hereinafter called “LNS”) installed in ISP, as disclosed, for example, in JP-A-2002-354045 (Related Art 2). A PPP packet from a terminal (an IP packet from the terminal is included in a payload) is encapsulated into an L2TP packet in LAC, and then transferred to LNS through an L2TP connection. Then, LNS performs protocol processing which involves terminating the L2TP connection and PPP connection (removed from the capsule), and adding a predetermined signal to the IP packet included in payload information of the PPP packet, and transfers the processed IP packet to the server of ISP or the like. In the reverse direction, LNS encapsulates an IP packet into PPP and L2TP packets, and LAC terminates the L2TP connection, and transfers the PPP packet to a subscriber terminal.

In communications through the Internet, packets are transferred from an originating device to a receiving device through a network based on IP addresses assigned to IP packets which carry information. In this event, the IP address is a simple sequence of numerals and can be frequently changed due to movements of devices and the like, so that the IP address is not easily handled as a universal address. Therefore, when a subscriber (user of a terminal or the like) identifies (specifies) a connection partner, it is a general tendency to use a terminal or a server identifier (for example, user.isp.co.jp) called a “user domain name” (hereinafter simply called the “domain name”). Then, within the network, the domain name is converted to the IP address for making communications using a technique called “DNS” defined in RFC1035 (2.1. Overview) of IETF (Related Art 3).

In a service which has recently been started and become increasingly popular, ISP uses Internet Protocol Control Protocol (hereinafter called “IPCP”) defined in RFC1332 (3.3 IP addresses) of IETF (Related Art 4) to automatically assign information such as an IP address to a terminal, a server (host), or the like, which temporarily connects to the Internet, for allowing communications, and automatically recovers the information at the end of the communications for assigning the information to another terminal device. When a communication partner utilizes this service, the IP address of the communication partner can be changed each time the communication partner connects to or disconnects from the Internet, so that even if a subscriber uses a domain name on purpose, the domain name cannot be corresponded to the IP address, thereby resulting in a failure of communications with the partner. To solve this problem, a technique called “dynamic DNS” has been introduced as defined in RFC2136 (4 Requestor Behavior) of IETF (Related Art 5), wherein a Domain Name System server (hereinafter called the “DNS server”) is provided for managing a domain name in association with the IP address of a terminal or a host, and correctly updating the correspondence of the domain name to the IP address on the DNS server in spite of changes in the IP address, thereby permitting a connection requesting user to identify a connection partner, the IP address of which has been changed, even if the user uses a domain name.

In a communication network which uses the dynamic DNS function defined in RFC2136, the user must make a contract with a dynamic DNS service provider in addition to a contract with ISP for utilizing the Internet. Also, each time the user of a terminal or a host changes an IP address, the user must register again the changed IP address in a registration server (DNS server) of the dynamic DNS service provider. Moreover, since a different user ID and password are required for ensuring the security of DNS, the user experiences burdensome operations. To eliminate such inconvenience, JP-A-2003-169077 (Related Art 6) discloses techniques for associating a dynamically changing IP address with a domain name for registration in a DNS server when an authentication server provided by ISP authenticates a terminal or a host for connection to the Internet.

However, the network topology described in JP-A-2002-354045 does not take into consideration the topology and operation of an access network for setting an L2TP tunnel by LAC and LNS, which has been recently introduced more and more. This leads to the inability to detect possible troubles and faults in the L2TP tunnel. In addition, since the authentication server itself does not directly accommodate terminals or hosts (hereinafter they may be collectively called the “host”), a fault in the host cannot either be detected through confirmation of conduction. Therefore, when the L2TP tunnel and/or a host fail, the DNS server cannot successfully correspond (or update the correspondence of) a domain name to an IP address which has been changed due to a disconnection or the like, causing obstacles to communications, such as disabled connection, erroneous connection, and the like.

Also, the authentication server described in JP-A-2002-354045 registers a domain name in the DNS server in response to an accounting start message, and deletes a domain name in response to an accounting stop message, so that when the authentication server is not responsible for accounting control, such messages are not communicated, and therefore, there is no opportunity to access the DNS server. Specifically, even if an IP address has been changed due to a connection to or disconnection from the Internet, the DNS server cannot correspond (or update the correspondence of) the domain name to the IP address, causing obstacles to communications as well.

Further, the authentication server described in JP-A-2002-354045 does not support a system which has duplicated DNS servers, so that if a main DNS server fails and therefore is switched to a spare DNS server, the authentication server cannot access to the spare DNS server. Consequently, the DNS server cannot correspond (or update the correspondence of) a domain name to an IP address, causing obstacles to communications as well.

### SUMMARY OF THE INVENTION

The present invention has been made in view of the foregoing problems, and it is an object of the present invention to provide a packet transfer apparatus which is capable of improving the safety and reliability of communications through the Internet by readily and exhaustively registering, deleting, and updating a correspondence of an IP address to a domain name in a DNS server.

To solve the above problems, when the packet transfer apparatus receives an IP address supplied to a terminal accommodated therein from an ISP network each time the terminal performs a control for connection to the Internet, the packet transfer apparatus corresponds the domain name of the terminal to the received IP address, and notifies a DNS server installed in the ISP network of the correspondence in response to a control operation such as a predetermined packet transfer.

Specifically, the packet transfer apparatus transmits the correspondence of a stored domain name of a terminal to an IP address assigned to the terminal to the DNS server installed in the ISP network, in addition to an operation performed by the packet transfer apparatus in the event of authentication of the terminal for notifying the terminal of the result of the authentication and an IP address assigned to the terminal from an ISP network.

Also, when a terminal disconnects a connection to the Internet, the packet transfer apparatus deletes the stored IP address in response to a control operation such as the disconnection, and instructs the DNS server installed in the ISP network to delete the correspondence to the domain name to this IP address. Further, the packet transfer apparatus monitors terminals for connection states in which the terminals connect to the Internet. Upon occurrence of a trouble in connection states, the packet transfer apparatus deletes the stored IP address in response to a connection operation such as a disconnection, or a control operation such as a predetermined packet transfer, and instructs the DNS server installed in the ISP network to delete the correspondence of the domain name to the IP address.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram illustrating an exemplary network topology of a communication network in which packet transfer apparatuses of the present invention are used;

FIG. 2 is a sequence diagram (1) illustrating an exemplary operation of the communication network in FIG. 1;

FIG. 3 is a block diagram illustrating an exemplary configuration of the packet transfer apparatus;

FIG. 4 shows an exemplary structure of a user information table created in the packet transfer apparatus;

FIG. 5 is a sequence diagram (2) illustrating an exemplary operation of the communication network in FIG. 1;

FIG. 6 is a sequence diagram illustrating another exemplary operation of the communication network in FIG. 1; and

FIG. 7 is a sequence diagram illustrating a further exemplary operation of the communication network in FIG. 1.

### DESCRIPTION OF THE EMBODIMENTS

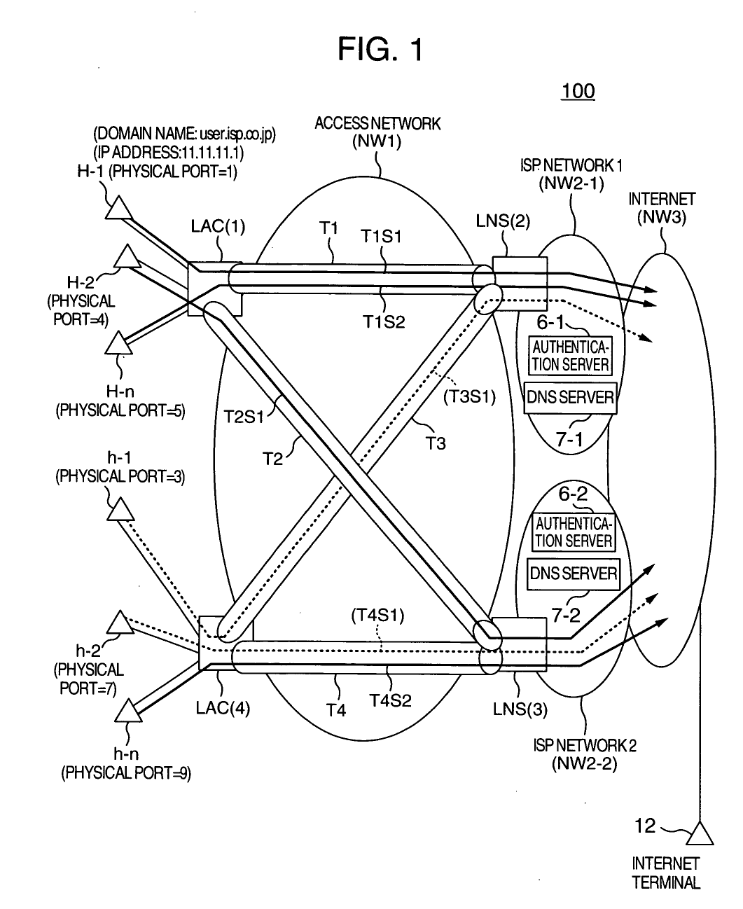

In the following, one embodiment of a packet transfer apparatus according to the present invention will be described in detail with reference to the accompanying drawings. FIG. 1 is a diagram illustrating an exemplary network topology of a communication network in which the packet transfer apparatuses of the present invention are used.

A communication network (100) comprises an access network (NW1) for connection to ISP networks (NW2-1, 2) which are communication networks managed by respective ISPs which accommodate terminals (H-1-H-n, h-1-h-n) of a plurality of subscribers who utilize the Internet, and provides Internet services to the subscribers using Internet Protocol (hereinafter called “IP”); the Internet (NW3) for interconnecting the ISP networks (NW2-1, NW2-2); and a terminal 12 connected to the Internet (NW3) in a similar form to the terminals (H-1-H-n, h-1-h-n) of the subscribers. Each of the subscribers concludes a contract with appropriate ISP in terms of Internet connection, and communicates between terminals (for example, between the terminal (H-1) and terminal (12)) utilizing the communication network (100) as illustrated. In the description made below, the terminals (H-1-H-n, h-1-h-n) accommodated in the access network (NW1) are called the “host” (H-1-H-n, h-1-h-n) for distinguishing them from the terminal 12.

In FIG. 1, the access network (NW1) is a communication network which can accommodate a variety of ISPs, and a local IP network managed by NTT, for example, may be used for the intended purpose. The ISP networks (NW2) in turn are communication networks managed by associated ISPs and connected to the Internet (NW3). Each of the ISP networks (NW2) comprises an authentication server (6-1, 6-2) responsible for authentication, accounting, and the like of Internet subscribers (contractors); and a DNS server (7-1, 7-2) for managing IP addresses and domain names. The packet transfer apparatuses (1-4) of this embodiment are installed in the access network (NW1), as illustrated. Each packet transfer apparatus (1-4) forms an L2TP tunnel (T1-T4) on the access network (NW1), and transfers packets between a host (H-1-H-n, h-1-h-n) and the ISP network (NW2). Moreover, each packet transfer apparatus (1-4) corresponds a domain name of a host (H-1-H-n, h-1-h-n) to an IP address supplied to the host (H-1-H-n, h-1-h-n) by the ISP network (NW2) each time a connection control (for example, authentication) is conducted for the host (H-1-H-n, h-1-h-n), and notifies the DNS server (7) installed in the ISP network of the correspondence in response to a control operation such as a packet transfer, thereby causing the DNS server to readily and securely register, delete, or update the correspondence of the IP address to the domain name. In the following description, those of the packet transfer apparatuses (1-4) installed in association with the hosts (H-1-H-n, h-1-h-n) are called LACs (1, 4), while those installed in association with the ISP networks (NW2) are called LNS (2, 3). Also, while a plurality of L2TP sessions (T1S1-TnSm) are formed in the L2TP tunnels (T1-T4) for each host (H-1-H-n, h-1-h-n), the L2TP sessions are simply called the “tunnels” in the following description.

The communication network (100) of FIG. 1 illustrates an exemplary topology which comprises two each of the LAC (1, 4) and LNS (2, 3), and two ISPs (NW2-1, NW2-2). Then, each of the plurality of hosts (H-1-H-n, h-1-h-n) concludes a contract with any ISP for making a connection to the Internet (NW3). In LAC (1), a host (H-1) which has concluded a contract with ISP that manages the ISP network (NW2-1) and has a domain name (user.isp1.co.jp); a host (H-n) which has concluded a contract with ISP that manages the ISP network (NW2-1) and has a domain name (mike.isp1.co.jp); and a host (H-2) which has concluded a contract with ISP that manages the ISP network (NW2-2) and has a domain name (hanahana.isp2.co.jp) are accommodated respectively in physical ports 1, 5, 4 of the packet transfer apparatus. Details of the packet transfer apparatus will be shown when its configuration is described later. On the other hand, in LAC (4), a host (h-1) which has concluded a contract with ISP that manages the ISP network (NW2-1) and has a domain name (pochi.isp1.co.jp); a host (h-2) which has concluded a contract with ISP that manages the ISP network (NW2-2) and has a domain name (tama.isp2.co.jp); and a host (h-n) which has concluded a contract with ISP that manages the ISP network (NW2-2) and has a domain name (muku.isp2.co.jp) are accommodated respectively in physical ports 3, 7, 9 of the packet transfer apparatus.

While the IP address (11.11.11.1) of the host (H-1) is described as an example of an IP address in FIG. 1, this address is assigned from ISP when the host (H-1) connects to the ISP network (NW2-1) and recovered when the host (H-1) disconnects from the ISP network (NW2-1), and is given as an example of an IP address which can be changed each time the host is connected. A similar IP address is assigned to any other host from associated ISP when the host connects to an associated ISP network, and recovered when the host disconnects from the ISP network. The packet transfer apparatuses (1-4) of the present invention correspond these IP addresses to domain names and then automatically notify the DNS server of the correspondence, in addition to a packet transfer through the formation of the tunnel (T1S1-TnSm) on the access network (NW1), described below. Upon receipt of the notification, the DNS server (7) registers, updates and/or deletes addresses to maintain the most recent correspondence of domain names to IP addresses.

When each host (H-1-H-n, h-1-h-n) connects to the Internet, the associated packet transfer apparatuses (LAC (1, 4) and LNS (2, 3)) form a tunnel (T1S1-TnSm) in the access network (NW1) in order to transfer packets. In this example, the host (H-1) and host (H-n) communicate with the ISP network (NW2-1) using tunnels (T1S1, T1S2) formed by the packet transfer apparatuses (LAC (1) and LNS (2)). The host (H-2) in turn communicates with the ISP network (NW2-2) using a tunnel (T2S1) formed by the packet transfer apparatuses (LAC(1) and LNS (3)). Similarly, the host (h-1) communicates with the ISP network (NW2-1) using a tunnel (T3S1) formed by the packet transfer apparatuses (LAC (4) and LNS (2)), while the host (h-2) and host (h-n) communicate with the ISP network (NW2-2) using tunnels (T4S1, T4S2) formed by the packet transfer apparatuses (LAC (4) and LNS (3)). A tunnel indicated by a solid line (for example, T1S1) of the tunnels in FIG. 1 means that the tunnel is currently involved in a connection, while a tunnel indicated by a broken line (for example, T3S1) means that the tunnel is not currently involved in a connection. By thus using the packet transfer apparatuses (LAC (1, 4) and LNS (2, 3)), each of the hosts (H-1-H-n, h-1-h-n) can transfer (communicate) packets as if a dedicated line were built in the access network (NW1) up to the ISP network (NW2).

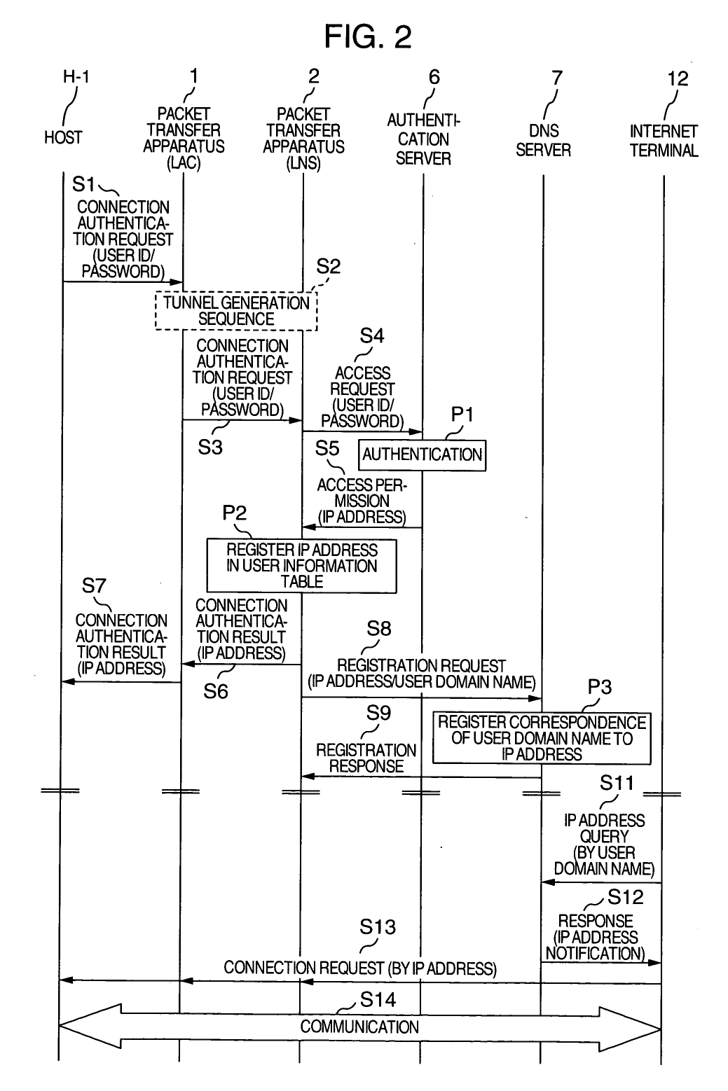

FIG. 2 is a sequence diagram illustrating the exemplary operation of the communication network in FIG. 1. In the following, the operation of the communication network (100) and the operation of the packet transfer apparatuses (1-4) will be described, with reference also to FIG. 1, for an example in which the host (H-1) communicates with the terminal (12) connected to the Internet (NW3) through the ISP network (2-1) using a tunnel (T1S1) formed between LAC (1) and LNS (2) of the access network (NW1).

Upon receipt of a connection authentication request (PPP packet) from the host (H-1) for requesting a connection to the ISP network (NW2-1) (step S1), LAC (1) determines an address for LNS (2) from the user ID of the host (H-1) included in the connection authentication request for forming the tunnel (T1S1), using a procedure as described in RFC2661 (2.0 Topology, 3.0 Protocol Overview, 5.0 Protocol Operation, and 5.5 Keepalive), and starts establishing a tuunel T1 and an L2TP session passing through the tunnel T1 for LNS (2) to generate the tunnel (T1S1) (tunnel generation sequence (for details, see RFC2661 (2.0 Topology, 3.0 Protocol Overview, 5.0 Protocol Operation, and 5.5 Keepalive): step S2).

After confirming the generation of the tunnel (T1S1), LAC (1) encapsulates the connection authentication request (PPP packet) into an L2TP packet for transfer to LNS (2) (step S3). LNS (3) terminates the connection authentication request (removes the PPP packet from the capsule of L2TP packet), performs protocol processing such as addition of necessary signals, and transmits an access request to the authentication server (6-1) of the ISP network (NW2-1) (step S4). The configuration and operation of LAC (1) and LNS (2) will be described later in greater detail with reference to the drawings.

The authentication server (6-1) authenticates the user based on a user ID and a password included in the received access request (P1). Here, when the authentication server (6-1) determines that the host (H-1) can access to the internet NW3, the authentication server (6-1) transmits a permission notification including an IP address (11.11.11.1 in FIG. 1) assigned to the host (H-1) to LNS (2) (step S5).

LNS (2) stores the IP address given by the authentication server (6-1) of the ISP network (NW2-1) in correspondence to a line number of a line (a physical port number which is “1” in this example) in which the host (H-1) is accommodated in LAC (1) (P2). Specifically, LNS (2) is provided with a user information table (memory), such that the domain name, IP address and the like for identifying the host (H-1) are stored in this table in correspondence to the information on the line number, though details will be described later.

The information on the line number can be acquired by LAC (1) which accommodates the host (H-1) in a line interface (30-1-30-n) of the packet transfer apparatus, later described, and is also stored in LAC (1), such that the information is transferred to LNS (2). The transfer may be performed during the sequence of step S2, or may be performed using an empty band after the tunnel (T1S1) has been generated. Also, the information on the line number is not limited to a physical line number, but may be a logical line number (VLANID for an Ethernet (Ethernet is a registered trademark) line, VCI for an ATM line, and the like). In this example, since the user is identified using a physical line number based on a line number of a line to which the user terminal connects, rather than the user ID, fraudulent accesses such as spoofing can be effectively prevented. Also, information such as the domain name is provided when the host (H-1) concludes a contract with ISP, and is previously stored in the packet transfer apparatuses (1-4) after the contract, though details will be described later.

LNS (2) transmits the IP address (11.11.11.1), given as the result of connection authentication, to LAC (1) (step S6), and LAC (1), upon receipt of the result of connection authentication, notifies the host (H-1) of the result of connection authentication including the IP address (step S7).

LNS (2), which is the packet transfer apparatus of the present invention, stores the domain name for identifying the host (H-1) as mentioned above, IP address, and the like, and transmits the stored IP address (11.11.11.1) assigned to the host (H-1) and the domain name (user.isp.co.jp) corresponding to this IP address to the DNS server (7-1) installed in the ISP network (NW2-1) after LNS (2) has notified LAC (1) of the authentication result (step S8), in addition to general supports for the Internet connection service such as generation of a tunnel, authentication by a packet transfer, notification of an IP address, and the like.

The DNS server (7-1) registers the received IP address and user domain name in a memory within the DNS server (7-1) based on RFC1035 of IETF (P3), and returns a response to LNS (2) for informing that the registration has been completed (step S9).

Since the packet transfer apparatuses (LAC (1), LNS (2)) perform the sequence of operations as described above, the IP address assigned to the host (H-1) and its domain name are automatically notified to the DNS server (7) together with the authentication (part of the packet transfer (control operation) for connection to the Internet) of the host (H-1), so that the DNS server (7) registers, updates, or deletes the IP address and domain name. Specifically, the DNS server (7) is not controlled in response to an accounting message from the authentication server (6), but the DNS server (7) is accessed from the packet transfer apparatuses (LAC (1), LNS (2)) in response to a packet transfer (for example, notification of an IP address to the packet transfer apparatuses (LAC (1), LNS (2)) which is performed without exception in operations involved in a connection to the Internet (NW3). Consequently, since the correspondence of the IP address to the domain name can be readily and securely registered and updated in the DNS server, it is possible to prevent a connection disabled state and an erroneous connection which can occur due to a failure in corresponding a domain name to an IP address, thus improving the safety and reliability of communications over the Internet. Also, though details will be described later, since the packet transfer apparatus monitors the state of a packet transfer (communication) to automatically notify the DNS server (7) of an IP address and a domain name together with a connection/disconnection control to the Internet, the DNS server (7) can readily and securely accomplish an update or a deletion of the IP address and domain name associated with a defective communication state, thereby making it possible to build an Internet communication network which can prevent a connection disabled state and an erroneous connection and therefore excels in safety and reliability.

Even in a system which duplicates the DNS servers (7) in the ISP networks (NW2-1, 2), the steps (S8, S9) may be executed a plurality of times, or the DNS servers (7) may perform an operation for supporting the duplication (causing both of duplicated DNS servers (7) to register, update, or delete IP addresses and domain names with a single control), thus making it possible to built an Internet communication network which further excels in safety and reliability.

When the Internet terminal (12) communicates with the host (H-1), the Internet terminal (12) queries the DNS server (7-1) to find the IP address of the host (H-1) through the Internet (NW3) (step S11).

In the DNS server (7-1), the IP address of the host (H-1) corresponding to the domain name is securely registered, updated, or deleted as described above, and the DNS server (7-1) notifies the Internet terminal (12) of the IP address information on the host (H-1) from the recently stored information (step S12), thereby permitting the Internet terminal (12) to acquire the IP address of the host (H-1).

Subsequently, the Internet terminal 12 requests the host H-1 for connection using the acquired IP address (step S13), and can communicate with the host H-1 (step S14). As will be later described, when a fault occurs in the communication network, the IP address is not notified (the fault is notified), so that an unaccountable communication disabled state and an erroneous connection can be prevented at the connection requesting terminal.

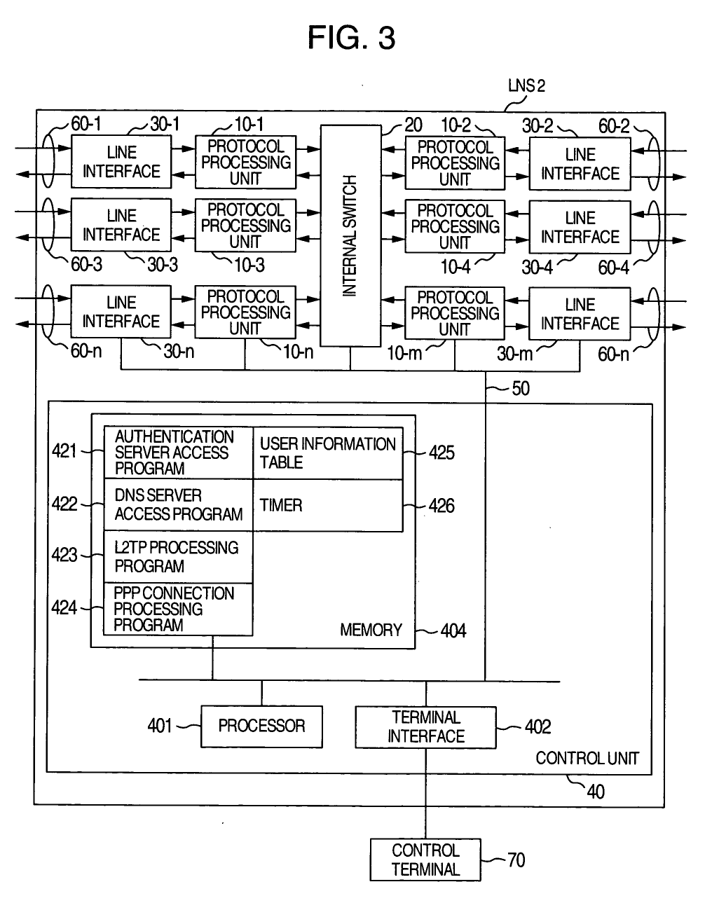

FIG. 3 is a block diagram illustrating an exemplary configuration of the packet transfer apparatus. While the packet transfer apparatus (LNS (2)) in FIG. 1 will be described below for the configuration, the remaining packet transfer apparatuses, i.e., LAC (1, 4) and LNS (3) are similar in configuration to LNS (2).

LNS (2) comprises line interfaces (30-1-30-n) having input/output physical ports (60-1-60-n) which are interfaces for connecting to hosts and ISP networks; protocol processing units (10-1-10-n); an internal switch (20); and a control unit (40) for generally controlling LNS (2). The respective functional blocks are connected through a control line (50) and the like, as illustrated. The control unit (40) comprises a terminal interface (402), such that LNS (2) can be controlled by an external control terminal (70).

The line interface (30) receives a signal in a communication frame format in accordance with a communication protocol on an input/output line from the input/output physical port (60) for connection with an ISP network or a host, for example, Ethernet (Ethernet is a registered trademark), ATM, or the like, converts the received signal into a predetermined packet which is transferred to the protocol processing unit (10). In the reverse direction, the line interface (30) converts a predetermined packet received from the protocol processing unit (10) into a signal in a communication frame format in accordance with the communication protocol on the input/output line, for example, Ethernet, ATM, or the like, and sends the converted signal to an ISP network or a host. The line interface (30) also detects troubles and faults in communicated signals such as interruption of an input/output signal.

The protocol processing unit (10) performs PPP termination processing or L2TP termination processing for predetermined packets and PPP packets received from a line interface (30-i) in association with the control unit (40), and also performs processing required for execution of each protocol such as transmission/reception of control messages associated with each protocol, encapsulation of packets, decapsulation of packets, and the like. The protocol processing unit (10) also detects faults and errors in signals to be communicated and in formed tunnels.

The internal switch (20) transfers packets received from each protocol processing unit (10) to a protocol processing unit which is connected to any line interface (30) that has an output port in accordance with a predetermined address.

The control unit (40) monitors the states of the line interfaces (30), protocol processing units (10), and internal switch (20), and sets a variety of control parameters for the line interfaces (30) and protocol processing units (10) and sets the internal switch (20) in accordance with their respective states. The control unit (40) may also notify the control terminal (70) of information on a monitored internal state of the packet transfer apparatus through the terminal interface (402), control each functional block in response to an instruction from the control terminal (70), and set control parameters for each functional block.

Specifically, the control unit (40) comprises a processor (401) for executing each of the aforementioned processing; a memory (404) for storing software (program or firmware) and data for the processor (401) to execute the processing; and an interface (402) with the control terminal (70). The operations described in connection with FIG. 2, which include the generation of a tunnel, transfer of packets for requesting authentication, notification of the authentication result, and the like, acquisition and storage of an IP address, and registration, update, deletion, and the like of an IP address in the DNS server in response to a notification to the DNS server, are realized by the processor (401) which executes programs, later described, to directly control the line interfaces (30), protocol processing units (10), and internal switch (20) or to set control parameters to operate a processor or the like, not shown, in each functional block.

LNS (2) in this embodiment comprises programs which have the following functions.

(a) L2TP processing program (423) for building an L2TP tunnel between LAC and LNS:

The L2TP processing program (423) has a function of generating the tunnel T1S1 at step S2 in FIG. 2, for example, between LAC (1), which has received a connection authentication request from the host (H-1), and LNS (2). When running on LNS (2), the L2TP processing program (423) generates the tunnel T1S1 by transmitting and receiving control signals to and from LAC (1) (associated with the L2TP processing program (423) provided in LAC (1)).

(b) PPP connection processing program (424) for performing PPP processing and user authentication to permit a host to connect to the Internet:

For example, when running on LAC (1), the PPP connection processing program (424) has functions of receiving a connection authentication request (PPP packet) from the host (H-1) (at step S1 in FIG. 2), encapsulating the connection authentication request into an L2TP packet and transferring the L2TP packet to LNS (2) (at step S3 in FIG. 2), and notifying the host (H-1) of the result of the connection authentication (at step S7 in FIG. 2). When running on LNS (2), the PPP connection processing program (424) has functions of terminating the PPP packet (part of step S4 in FIG. 2), and notifying the LAC (1) of the authentication result (at step S6 in FIG. 2).

(c) Authentication server access program (421) for controlling accesses to the authentication server (6) installed in the ISP network for authenticating the user:

For example, the authentication server access program (421), when running on LNS (2), has functions of transmitting an access request to the authentication server (part of step S4 in FIG. 2), and receiving an access permission from the authentication server (6-1) and acquiring an IP address (at step S5 in FIG. 2). This function may be provided in LAC (1) to pass LNS (2) through the tunnel T1S1. In this event, step P2 in FIG. 2 is executed by LNS (1).

(d) DNS server access program (422) for notifying a user domain name, an IP address and the like to the DNS server installed in the ISP network to instruct registration and deletion:

For example, the DNS server access program (422), when running on LNS (2), has functions of storing the IP address of the host (H-1) assigned from the authentication server (6-1) in correspondence to the domain name (at step P2 in FIG. 2), transmitting a request for registering an IP address and an associated domain name to the DNS server (7-1) based on the stored contents (at step S8 in FIG. 2), and confirming a response from the DNS server (7-1) (at step S9 in FIG. 2).

Alternatively, the step P2 in FIG. 2 may be executed by the aforementioned authentication server access program (421), or this function may be provided in LAC (1) in a manner similar to the authentication server access program (421). Also, in a system which duplicates the DNS servers (7) in the ISP networks (NW2-1, NW2-2), the steps (S8, S9) may be executed a plurality of times, or the DNS servers (7) may perform an operation for supporting the duplication (causing both of duplicated DNS servers (7) to register, update, or delete IP addresses and domain names with a single control).

The program (d) accesses the DNS server (7) from the packet transfer apparatuses (LAC (1), LNS (2)) in response to a control operation such as a packet transfer (for example, notification of an IP address to the packet transfer apparatuses (LAC (1), LNS (2)) which is performed without exception for connecting to the Internet (NW3). Giving an example, the control unit (40) in FIG. 3 once stores the IP address of the host (H-1) in correspondence to the domain name in a table, details of which will be described later (at step P2 in FIG. 2), identifies the host from information on the number of a line through which the packet passes in response to a predetermined packet transfer, and searches the table to retrieve the IP address and domain name stored therein. The control unit (40) issues a registration request including the retrieved IP address and user domain name to the DNS server (7-1) (at step S8 in FIG. 2), and confirms the result of the processing (registration, update, or deletion of the IP address and domain name) from the DNS server (7-1) which has received the registration request (at step S9 in FIG. 2).

The aforementioned division of the functions provided by the respective programs, and the allocation of the functions to LAC and LNS are simple examples, and the functions may be divided and/or allocated in a different manner to provide a single program or four or more programs. In any case, the processor (401) of the packet transfer apparatus executes these programs to have a function of transmitting/receiving signals as shown in the sequence diagram of FIG. 2 through the line interfaces (30), protocol processing units (10), and internal switch (20), such that the IP address and domain main are automatically notified to the DNS server (7) in response to a control operation such as a packet transfer which is performed without exception for connecting to the Internet (NW3), such as authentication of the host (H-1) (part of a packet transfer for connection to the Internet), to permit the DNS server (7) to register, update, or delete the IP address and domain name.

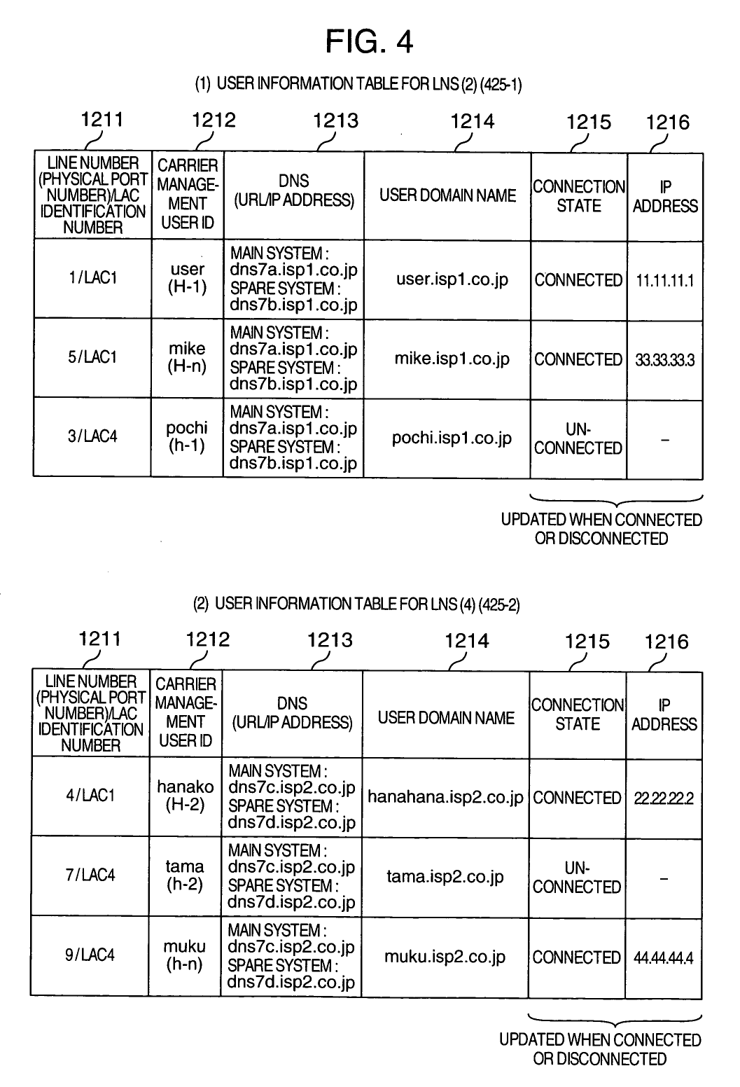

FIG. 4 shows an exemplary structure of the user information table (425) created on the memory (404) provided in the control unit (404). The user information table (425), which is formed and updated when the processor (401) executes the aforementioned programs, stores the correspondence of the domain names of the hosts (H-1-H-n, h-1-h-n) to the IP addresses assigned thereto from the ISP network upon connection to the Internet. The user information table (425) is used to permit the packet transfer apparatus (1-4) to instruct the DNS server (7) to automatically register, update, or delete an IP address and a domain name based on the contents of the table. It should be noted that FIG. 4 shows an exemplary structure of the user information table (425) created in LNS (2, 3) in a connection state of the communication network (100) illustrated in FIG. 1.

The user information table (425) is comprised of line number information (physical port number in this example. See FIG. 1) indicative of where each host (H-1-H-n, h-1-h-n) is accommodated in LAC, and identification number information of LAC itself (1211); carrier management user (host H) ID information (1212) managed by the ISP; address information (URL and IP address) (1213) of the DNS server (7) installed in a contracted ISP network; user domain name information (1214) of each host (H-1-H-n, h-1-h-n); connection state information (1215) indicative of whether or not each host (H-1-H-n, h-1-h-n) is connected to the Internet (NW3); and IP address information (1216) of each host (H-1-H-n, h-1-h-n) assigned by the authentication server (6).

Here, the domain name information (1214) is provided when the host (H-1) concludes a contract with some ISP. After the contract, the manager of the access network (NW1) is notified of this information, such that the manager of the access network (NW1) previously stores the domain name information (1214) in the packet transfer apparatuses (1-4) using the control terminal (70) in FIG. 3. The identification number information (1211) can be known when a terminal is accommodated in any of the packet transfer apparatuses (1-4) after each host (H-1-H-n, h-1-h-n) has concluded a contract with the access network (NW1). Therefore, upon accommodation of each host (H-1-H-n, h-1-h-n), the manager of the access network (NW1) may previously store the identification number information (1211) in the associated packet transfer apparatus using the control unit (70) in FIG. 3, or the packet transfer apparatus may automatically detect the accommodation of each host (H-1-H-n, h-1-h-n) to store the identification number information (1211).

As shown in the following description on the operation, each of the packet transfer apparatus (1-4) rewrites the user information table (425) in accordance with whether or not the respective hosts (H-1-H-n, h-1-h-n) are connected to the Internet (NW3), and registers, updates, or deletes the contents of the DNS server (7). For example, once the host (H-1) has terminated a communication, the associated packet transfer apparatus changes the connection state (1215) of the host (H-1) to “unconnected,” and deletes “11.11.11.1” from the IP address (1216). When the host (H-1) again starts a connection to the Internet (NW3), the packet transfer apparatus changes the connection state (1215) of the host (H-1) to “connected,” and writes a newly assigned IP address into the IP address (1216) (updates the IP address (1216)). Specifically, since LNS (2) can find information on a connection control associated with the host (H-1) (the number of a line in which the host (H-1) is accommodated) each time the host (H-1) is connected to or disconnected from a line, LNS (2) searches the user information table (425) for the previously set user domain name information (1213) based on the line number (1211) of the line in which the host (H-1) is accommodated to register, update, or delete the IP address (1215). Subsequently, LNS (2, 3) transmit the information stored in the updated user information table (425) to the DNS server (7) to automatically instruct the DNS server (7) to register, update, or delete the assigned IP address and the domain name.

Though detailed description is omitted in the network topology illustrated in FIG. 1, the contents of the user information table (425) in FIG. 4 is created on the premise of a system configuration which duplicates the DNS servers (7) for a main system and a spare system. Specifically, the DNS servers (7) in the respective systems have different address information (1213) (in this example, dns7a.isp1.co.jp for the main DNS server, and dns7b.isp1.co.jp for the spare DNS server) which are stored in the user information table (425). By executing the aforementioned steps (S8, S9) a plurality of times, or by performing the operation for supporting the duplication in the DNS servers (7) (causing both of duplicated DNS servers (7) to register, update, or delete IP addresses and domain names with a single control), the latest and consistent contents are maintained in the duplicated DNS servers. In such a configuration, even if some trouble occurs in the main DNS server, the main DNS server can be immediately and forcedly switched to the spare DNS server which stores the latest contents. Thus, a host in connection will not be disabled to communicate, or make an erroneous connection, or need manipulations for re-authentication, and can make communications through the Internet which excels in maintenanceability, reliability, and safety. When LNS recognizes a fault in the main DNS server, LNS may switch the address of the main DNS server to the address of the spare DNS server to access the spare DNS server for informing the fault and the contents of the user information table in the main DNS server, thereby providing further improved maintenanceability, reliability, and safety.

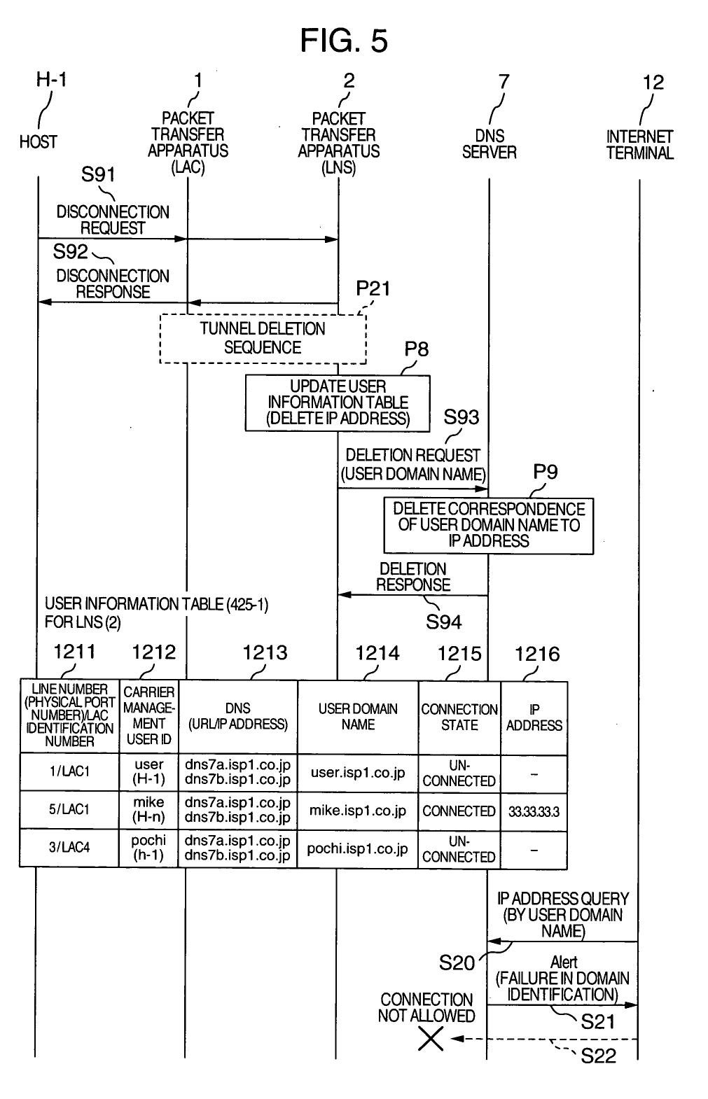

FIG. 5 is a like sequence diagram illustrating the operation of the communication network in FIG. 1, representing the operation for normally deleting host information in the communication network using the packet transfer apparatuses (1-4). Before the sequence of FIG. 5 is started, the host (H-1) is communicating with the terminal (12) through LAC (1), LNS (2), ISP network (NW2-1), and Internet (NW3) in accordance with the sequence diagram of FIG. 2.

When the host (H-1) issues a disconnection request (step S91), a disconnection response is returned from LNS (2) to the host (H-1) (step S92). Subsequently, a tunnel deletion sequence (details of which are omitted), substantially reverse to the tunnel generation sequence (step S2), activates between LAC (1) and LNS (2) to delete the tunnel (T1S1) (step P21). In this example, the control units (40 in FIG. 3) of LAC (1) and LNS execute (a) L2TP processing program (423) and (b) PPP connection processing program (424) to implement the foregoing deletion. Though not shown, the tunnel (T1S1) drawn by a solid line in FIG. 1 is changed to a broken line.

Subsequently, LNS (2) identifies the disconnected host (H-1) from the line number of the line to which the host (H-1) has been connected, and deletes the IP address information corresponding to the user domain name from the user information table (425) in order to update the connection state information (1215) and IP address information (1216) in the user information table (425) (step P8). Specifically, in the user information table (425) shown in FIG. 4, LNS (2) changes the connection state information (1215) corresponding to the line number information/LAC identification number (1211) from “connected” to “unconnected,” and deletes the IP address “11.11.11.1” stored in the IP address (1216) (see a table (425-1) in FIG. 5).

Next, LNS (2) notifies the DNS server (7-1) of the domain name of the host (H-1), and issues a request for deleting the IP address “11.11.11.1” corresponding to the domain name in the DNS server (7-1) (step S93).

Upon receipt of the deletion request, the DNS server (7-1) deletes the received user domain name, and the IP address data which has been registered in correspondence to this user domain name based on RFC1035 of IETF (step P9), and returns a deletion response message indicative of the completion of the deletion to LNS (2) (step S94). In this example, the control unit (40 in FIG. 3) of LNS (2) executes (d) DNS server access program (422) to perform the operation other than the DNS server (7-1).

When the terminal (12) accesses the host (H-1) after the foregoing operation, the terminal (12) transmits the domain name to the DNS server (7-1) through the Internet (NW3) to ask the DNS server (7-1) for the IP address of the host (H-1) (step S20). However, since the DNS server (7-1) does not store information on the correspondence of the specified domain name to the IP address, the DNS server (7-1) returns an alert message to the terminal (12) (step S21). In other words, though the terminal (12) cannot connect to the host H-1 (make a connection request) because it cannot acquire the IP address of the host (H-1) (step S22), the connection requesting terminal can prevent an unknown connection disabled state and an erroneous connection, resulting in improved safety and reliability of the communication network.

When the host (H-1) again makes a connection to the Internet (NW3), the host (H-1) is assigned a new IP address in a similar procedure to that illustrated in FIG. 2. Since this IP address is registered (updated) in the DNS server (7-1), the terminal (12) can make a communication with the newly assigned IP address acquired from the domain name.

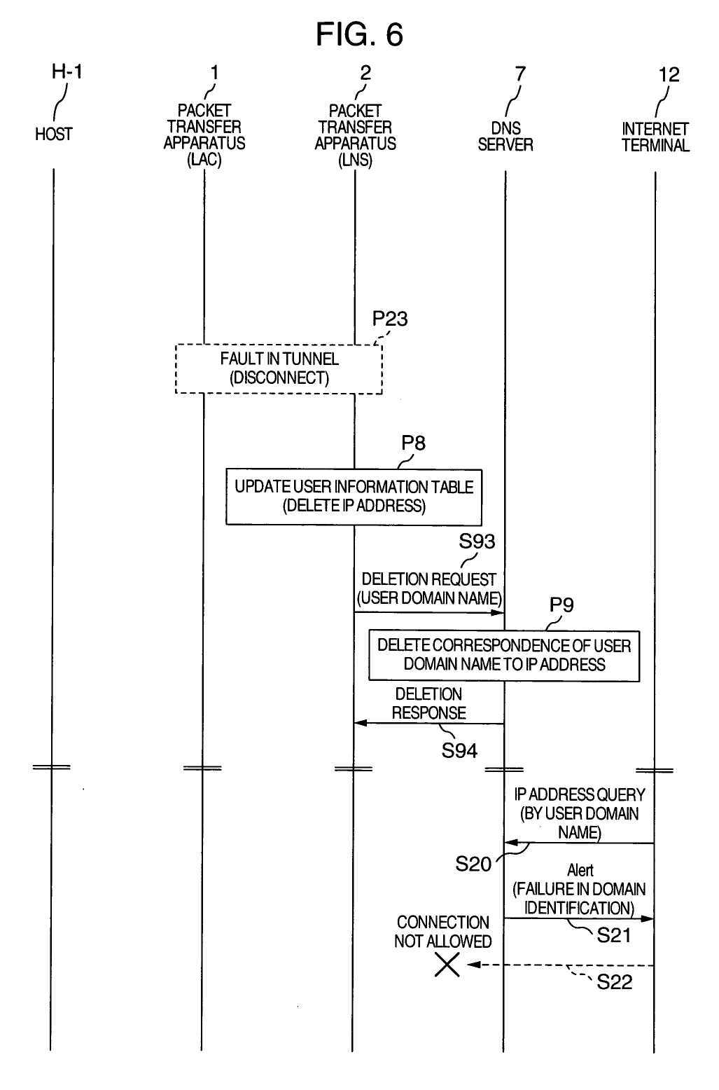

FIG. 6 is a sequence diagram illustrating another exemplary operation of the communication network in FIG. 1, representing the operation performed when the packet transfer apparatus (1-4) detects a fault in a tunnel. Before the sequence of FIG. 6 is started, the host (H-1) is communicating with the terminal (12) in accordance with the sequence diagram of FIG. 2, as is the case with the aforementioned normal disconnection operation.

As previously described, the packet transfer apparatus (1-4) is based on L2TP to generate a tunnel on the access network (NW1), and once encapsulate received packets into L2TP packets which are transferred for allowing the packets of the second layer of the OSI reference model to pass a network on the third layer between the host (H-1-H-n, h-1-h-n), and to output packets removed from capsules at the terminal. Therefore, the packet transfer apparatus needs a function of transferring packets while confirming the normality of the generated tunnel. Taking the configuration of FIG. 3 as an example, the packet transfer apparatus detects a fault in the tunnel with the operation of each functional block such as the line interface (30), protocol processing unit (10), and the like, and associated operations of the functional blocks.

Examples of specific detection method include detection of link down on the physical layer (first layer), and a method of detecting a fault in the tunnel through confirmation of packet conduction with Echo-Request and Echo-Reply signal of PPP defined by RFC1661 (5.8 Echo-Request and Echo-Reply) (Related Art 7) of IETF, or a keep alive signal of L2TP defined by RFC2661 (Related Art 3) of IETF (hereinafter these signals are collectively called the “keep alive signals”). Of course, any method other than the foregoing may be used instead.

If a fault occurs in the tunnel, a fault is also found in a communication between the host (H-1-H-n, h-1-h-n) and the terminal (12), so that the packet transfer apparatus (1-4) may delete the tunnel (T1S1-TnSm). In this event, unless the contents of the DNS server (7) are immediately updated to the recent state, the DNS server (7) cannot appropriately correspond a domain name to an IP address (or update the correspondence), possibly interfering with communications. The packet transfer apparatus (1-4) of the present invention takes advantage of the functions of accessing the DNS server (7) in response to a control operation such as a predetermined packet transfer, which is performed for connecting to the Internet (NW3), to readily and securely register or update the correspondence of the IP address to the domain name in the DNS server, and is responsive to a fault in the tunnel for disconnecting the tunnel (T1S1-TnSm) and automatically accessing the DNS server (7) in response to the disconnection to further improve safety and reliability of communications through the Internet.

When a fault, such as an interruption of transmitted/received packets in the tunnel (T1S1) utilized by the host (H-1) between LAC (1) and LNS (2), one or both of LAC (1) and LNS (2) detect the fault to disconnect the tunnel (T1S1) (step P23). In this example, the control units (40 in FIG. 3) of LAC (1) and LNS (2) execute (a) L2TP processing program (423) and (b) PPP connection processing program (424) to perform the foregoing operation, substantially in a similar procedure (details of which are omitted) to the tunnel deletion sequence (step P21) described above.

Since the control unit (40 in FIG. 3) knows which tunnel is used by which host, the control unit (40 in FIG. 3) identifies the host (H-1) to be disconnected from the line number of the line to which the host (H-1) is connected, and deletes IP address information corresponding to the user domain name from the user information table (425) in order to update the connection state information (215) and IP address information (1216) of the user information table (425) (step P8). Subsequently, the control unit (40 in FIG. 3) deletes the IP address data registered in correspondence to the user domain name from the DNS server (7-1) in a manner similar to the operation described in connection with FIG. 5 (steps S93, P9, S94).

As a result, though the terminal (12) cannot connect to the host (H-1) (steps S20-S22), the connection requesting terminal can prevent an unknown connection disabled state and an erroneous connection, resulting in improved safety and reliability of the communication network. Since an erroneous connection can be prevented, the communication network is improved in safety and reliability.

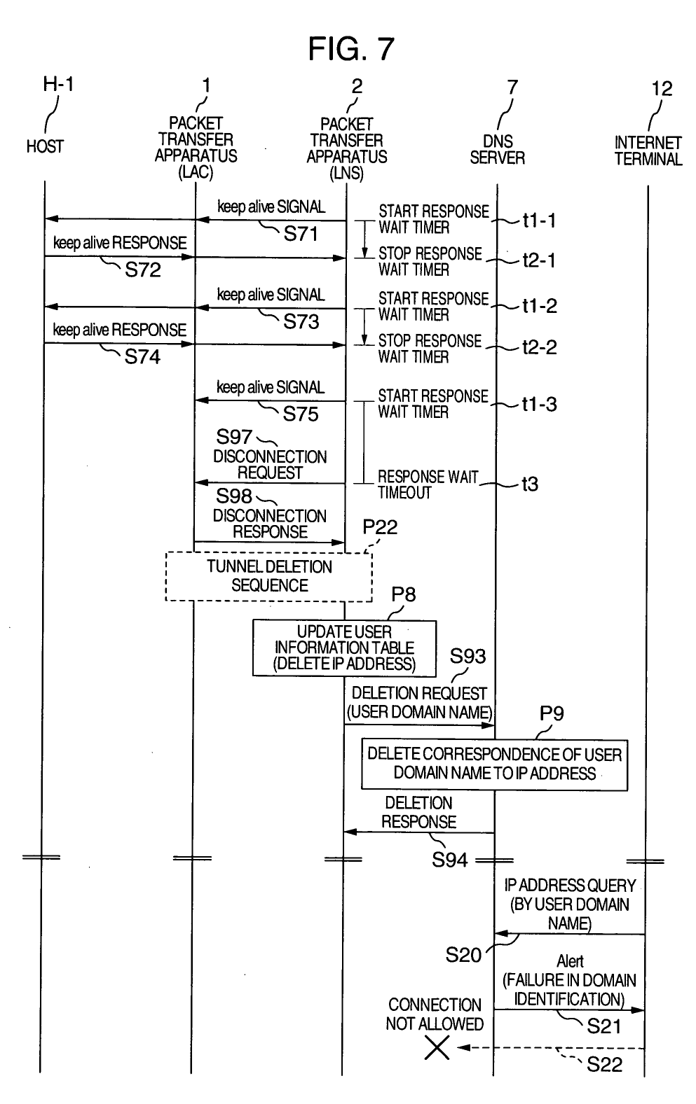

FIG. 7 is a sequence diagram illustrating another exemplary operation of the communication network in FIG. 1, representing the operation performed when the packet transfer apparatus (1-4) detects the absence of response from a host. Likewise, before the sequence of FIG. 7 is started, the host (H-1) is communicating with the terminal (12) in accordance with the sequence diagram of FIG. 2.

Like the state described in FIG. 6, the packet transfer apparatus (1-4) transfers packets from a host to another communication network (ISP network (2) in this example) using a tunnel on the access network (NW1). Therefore, the packet transfer apparatus needs a function of transferring packets while confirming the normality of the generated tunnel. Taking the configuration of FIG. 3 as an example, the packet transfer apparatus detects a fault (for example, power failure in the host) in a host with the operation of each functional block such as the line interface (30), protocol processing unit (10), and the like, and associated operations of the functional blocks. Since a host, if fails, cannot communicate with the terminal (12), the packet transfer apparatus (1-4) may delete a tunnel (T1S1-TnSm). In this event, unless the contents of the DNS server (7) are immediately updated to the recent state, communications will be interfered, as is the case with a fault in a tunnel described above. The packet transfer apparatus (1-4) of the present invention takes advantage of the functions of accessing the DNS server (7) in response to a control operation such as a predetermined packet transfer, which is performed for connecting to the Internet (NW3), to readily and securely register or update the correspondence of the IP address to the domain name in the DNS server, and is responsive to a fault in a host as well for disconnecting the host and automatically accessing the DNS server (7) in response to the disconnection to further improve the safety and reliability of communications through the Internet.

The packet transfer apparatus (LNS (2) in this example) transmits a keep alive signal (Echo-Request and Echo-Reply signal of PPP defined by RFC1661 5.8 (Related Art 7) of IETF, or a keep alive signal of L2TP defined by RFC2661 (Related Art 3) of IETF) to the host (H-1) for periodically confirming the conduction with the host (H-1), and receives a response from the host (H-1) to confirm whether or not the host (H-1) is alive and whether or not the line conducts. For this purpose, the line interface (30) and control unit (40) of LNS (2) are provided with a function of detecting these signals, and a timer (426). LNS (2) determines that the host (H-1) is normal if a time period (t2-t1) from the transmission of the keep alive signal (S71, S73) from LNS (2) to the reception of the keep alive response from the host (H-1) (S72, S74) is within a predetermined time period. When there is no response from the host (H-1) to the periodically transmitted keep alive signal (S75 and the like), LNS (2) determines that a timeout occurs, i.e., that the host (H-1) is faulty when LNS (2) does not receive the keep alive response by a predetermined time (t3) from the time the host (H-1) has received the keep alive signal. In this event, LNS (2) may determine that the host (H-1) is faulty when a single timeout occurs, or when several timeouts have occurred (after several retries).

Upon detection of a fault in the host (H-1), LNS (2) transmits a disconnection request signal to LAC (1) (step S97), and LAC (1) returns a disconnection response signal to LNS (2) (step S98). Then, LNS (2) disconnects the tunnel (T1S1) in association with LAC (1) which has received the disconnection request signal (step P22). In this example, the control units (40 in FIG. 3) of LAC (1) and LNS (2) execute (a) L2TP processing program (423) and (b) PPP connection processing program (424) to perform the aforementioned processing, substantially in a similar procedure (details of which are omitted) to the tunnel deletion sequence (steps P21, P22) described above.

Alternatively, LAC (1) may transmit the keep alive signal to the host (H-1) and receive the keep alive response from the host (H-1). In this event, the function of detecting the signals and the timer are provided in LAC (1), a fault in the host (H-1) is communicated to LNS (2), and the aforementioned signals are sent in opposite directions. Since the control unit (40 in FIG. 3) of LNS (2) knows which host (H-1 in this example) fails, the control unit (40 in FIG. 3) identifies the host (H-1) to be disconnected from the line number of the line to which the host (H-1) is connected, and deletes IP address information corresponding to the user domain name from the user information table (425) in order to update the connection state information (215) and IP address information (1216) of the user information table (425) (step P8), in a manner similar to the aforementioned exemplary operation.

Subsequently, the control unit (40 in FIG. 3) deletes the IP address data registered in correspondence to the user domain name from the DNS server (7-1) in a manner similar to the operation described in connection with FIG. 5 (steps S93, P9, S94). As a result, though the terminal (12) cannot connect to the host (H-1) (steps S20-S22), the connection requesting terminal can prevent an unknown connection disabled state and an erroneous connection, resulting in improved safety and reliability of the communication network. Since an erroneous connection can be prevented, the communication network is improved in safety and reliability.

Likewise, in the operations described in connection with FIGS. 5 to 7, description has been made on the division of the functions provided by the four programs, and the allocation of the functions, but these functions may also be divided and/or allocated in a different manner to provide a single program or four or more programs, as previously mentioned in the description of the respective programs. In any case, the processor (401) of the packet transfer apparatus executes these programs to have a function of transmitting/receiving signals as shown in the sequence diagrams of FIGS. 5 to 7 through the line interfaces (30), protocol processing units (10), and internal switch (20), such that the IP address and domain main are automatically notified to the DNS server (7) in response to a packet transfer or the like which is performed without exception for connecting to the Internet (NW3), to permit the DNS server (7) to register, update, or delete the IP address and domain name.

In the foregoing embodiment, the LNS (2) is provided therein with the user information table for sending a domain name delete request and the like to the DNS server (7-1). Alternatively, LAC (1) may be identical in configuration to LNS (2), such that LAC (1) performs the foregoing operations. Further alternatively, both LAC (1) and LNS (2) may store similar data to operate as appropriate, without difference in effects produced thereby.

Further, while in the foregoing embodiment, the authentication is performed in the authentication server (6-1), the function of the authentication server (6-1) may be ported to LNS (2).

According to the present invention, since the domain name and IP address of a terminal are automatically registered in the DNS server, the user of the terminal need not register the domain name and IP address in the DNS server each time the terminal is connected to the ISP network.

In addition, the correspondence of the IP address to domain name is readily and securely registered in, deleted from, or updated in the DNS server by automation, making it possible to improve the safety and reliability of the communication network. Specifically, since the correspondence of the IP address to domain name is readily and securely registered in, deleted from, or updated in the DNS server by automation in response to a control operation such as a packet transfer, which is performed without exception for connecting to the Internet, it is possible to prevent a connection disabled state and an erroneous connection which can be caused by a failure in corresponding the domain name to the IP address to improve the safety and reliability of communications through the Internet.

Also, since the IP address and domain name are automatically notified to the DNS server together with a connection to or a disconnection from the Internet by monitoring the state in which packets are transferred (communicated), an update or a deletion of the IP address and domain name, associated with a defective communication, can be readily and securely made in the DNS server. Consequently, the DNS server stores the most recent contents which reflect the state of the communication network. It is therefore possible to build a communication network which can prevent a communication disabled state and an erroneous connection and excels in safety and reliability.

It should be further understood by those skilled in the art that although the foregoing description has been made on embodiments of the invention, the invention is not limited thereto and various changes and modifications may be made without departing from the spirit of the invention and the scope of the appended claims.

1. A packet transfer apparatus for accommodating a plurality of terminals to transfer packets between said plurality of terminals and a communication network, said packet transfer apparatus comprising:
a plurality of interface units for transmitting packets to and receiving packets from said plurality of terminals or said communication network;
a switch unit for transmitting the packets received from one of said plurality of interfaces through another one of said interfaces; and
a control unit for generally controlling said packet transfer unit, wherein:
upon receipt of a connection request from an arbitrary terminal of said plurality of terminals to said communication network, said control unit transfers the connection request to said communication network,
upon receipt of a connection permission and an address for use by said terminal which has made the connection request from said communication network, said control unit requests said communication network to register previously stored information on said terminal and the received address in said communication network, and
said control unit transfers packets between said arbitrary terminal and said communication network using said plurality of interface units, said switch unit, and said received address.

2. A packet transfer apparatus according to claim 1, wherein: upon detection of a disconnection request from said arbitrary terminal or said communication network, said control unit stops transferring the packets, and requests said communication network to delete the received address.

3. A packet transfer apparatus according to claim 1, further comprising a monitoring unit for monitoring the transferred packets in said interface units, or said switch unit, or said control unit of said packet transfer apparatus, wherein:
when said monitoring unit detects an error in the packets transferred between said arbitrary terminal and said communication network, said control unit stops transferring the packets, and requests said
communication network to delete the received address.

4. A packet transfer apparatus according to claim 3, further comprising:
a timer disposed in said monitoring unit for monitoring an interval at which said arbitrary terminal receives or transmits packets, wherein:
when the packet transmission/reception interval exceeds a predetermined time period, said control unit recognizes a fault in said arbitrary terminal, stops transferring the packets, and requests said communication network to delete the received address.

5. A packet transfer apparatus according to claim 1, wherein:
said control unit requests said communication network to register the previously stored information on the arbitrary terminal and the address for use by said terminal after said control unit performs a predetermined control operation in response to receipt of a connection permission and the address from said communication terminal.

6. A packet transfer apparatus according to claim 2, wherein:
said control unit requests said communication network to delete the received address after said control unit performs a predetermined control operation in response to detection of an error in the transferred packets.

7. A packet transfer apparatus according to claim 6, wherein:
said control units comprises a processor and a memory, and
said processor stores or deletes the terminal information and the received address for use by the terminal in or from said memory, and registers or deletes the address in or from said communication network based on the contents in said memory.

8. A packet transfer apparatus according to claim 7, wherein:
said communication network is the Internet, the terminal information stored in said memory is a domain name of said terminal for use in the Internet, and said received address is an IP address assigned to said terminal on the Internet, and
said control unit transmits the domain name and the IP address, or the IP address to a DNS (Domain Name System) server installed in the Internet based on the contents of said memory.

9. A packet transfer apparatus installed in a first communication network for transferring packets between a plurality of terminals accommodated therein and a second communication network which has an authentication server and a DNS (Domain Name System) server, said packet transfer apparatus comprising:
a plurality of interface units for transmitting and receiving packets to and from said plurality of terminals or said second communication network;
a switch unit for transferring the packets between said plurality of terminals and said second communication network; and
a control unit for generally controlling said packet transfer apparatus, wherein:
upon receipt of a connection request to said second communication network from an arbitrary terminal of said plurality of terminals, said control unit forms a communication path in said first communication network with said plurality of interface units and said switch unit to transmit the connection request to said authentication server,
upon receipt of a connection permission and an IP address assigned to said arbitrary terminal from said authentication server, said control unit requests said DNS server to register the received IP address and identification information of said terminal corresponding to the IP address based on previously stored identification information of said terminal in said second network and the received IP address, and
said packet transfer apparatus transfers packets between said arbitrary terminal and said second communication network using said formed communication path.

10. A packet transfer apparatus according to claim 9, wherein:
upon detection of a disconnection request from said arbitrary terminal or said second communication network during the transfer of the packets through said formed communication path, said control unit disconnects said communication path, and requests said DNS server to delete the received IP address.

11. A packet transfer apparatus according to claim 9, further comprising a monitoring unit for monitoring the transferred packet in said interface units, or said switch unit, or said control unit of said packet transfer apparatus, wherein:
when said monitoring unit detects a fault on said communication path, said control unit disconnects said communication path, and requests said DNS server to delete the received IP address.

12. A packet transfer apparatus according to claim 9, further comprising:
a timer disposed in said monitoring unit for monitoring an interval at which said arbitrary terminal receives or transmits packets, wherein:
when the packet transmission/reception interval exceeds a predetermined time period, said control unit recognizes a fault in said arbitrary terminal, disconnects said communication path, and requests said communication network to delete the received address.

13. A packet transfer apparatus according to claim 10, wherein:
said control units comprises a processor and a memory, and
said processor stores or deletes the terminal information and the received address for use by the terminal in or from said memory, and registers or deletes the address in or from said DNS server based on the contents stored in said memory.

14. A packet transfer apparatus according to claim 9, wherein said first communication network is a communication network which uses L2TP (Layer-2 Tunneling Protocol), said formed communication path is an L2TP tunnel, said second communication network is the Internet, and said terminal identification information is a domain name of said terminal for use on the Internet.

15. A packet transfer apparatus installed in a first communication network for transferring packets between a plurality of terminals accommodated therein and a second communication network which has an authentication server and a Domain Name System (DNS) server, said packet transfer apparatus comprising:
a plurality of interface units for transmitting and receiving packets to and from said plurality of terminals or said second communication network;
a switch unit for transferring the packets between said plurality of terminals and said second communication network; and
a control unit for generally controlling said packet transfer apparatus, said control unit including a processor and a memory, wherein:
upon receipt of a connection request to said second communication network from an arbitrary terminal of said plurality of terminals, said processor forms a communication path in said first communication network using said plurality of interface units and said switch unit to transmit the connection request to said authentication server therethrough,
upon receipt of an access permission signal including IP address information assigned to said arbitrary terminal from said authentication server, said processor stores the received IP address information in correspondence to accommodation information of said terminal in said interface and domain name information previously stored in said memory,
said processor requests said DNS server to register the domain name information and the corresponding IP address in said DNS server based on the stored IP address information and the domain name information corresponding thereto, and
said packet transfer apparatus transfers packets between said arbitrary terminal and said second communication network using said formed communication path.

16. A packet transfer apparatus according to claim 15, wherein:
when said control unit detects a disconnection request from said arbitrary terminal or said second communication network during the transfer of the packets through said formed communication path, said processor disconnects said communication path, deletes the received IP address stored in said memory, and requests said DNS server to delete the IP address.

17. A packet transfer apparatus according to claim 15, further comprising a monitoring unit for monitoring the transferred packet in said interface units, or said switch unit, or said control unit of said packet transfer apparatus, wherein:
when said monitoring unit detects a fault on said communication path, said processor disconnects said communication path, deletes the received IP address stored in said memory, and requests said DNS server to delete the IP address.

18. A packet transfer apparatus according to claim 17, further comprising:
a timer disposed in said monitoring unit for monitoring an interval at which said arbitrary terminal receives or transmits packets, wherein:
when the packet transmission/reception interval exceeds a predetermined time period, said processor recognizes a fault in said arbitrary terminal, disconnects said communication path, deletes the received IP address stored in said memory, and requests said DNS server to delete the received address.

19. A packet transfer apparatus according to claim 15, wherein said first communication network is a communication network which uses L2TP (Layer-2 Tunneling Protocol), said formed communication path is an L2TP tunnel, and said second communication network is the Internet.
